(19) United States
(12) Patent Application Publication
(10) Pub. No.: US 2014/0178618 A1
(43) Pub. Date: Jun. 26, 2014

(54) DISPLAY DEVICE AND COVER MEMBER

(71) Applicant: Japan Display Inc., Minato-ku (JP)

(72) Inventors: Atsushi TANABE, Tokyo (JP); Ken HIRABAYASHI, Tokyo (JP)

(73) Assignee: Japan Display Inc., Minato-ku (JP)

(21) Appl. No.: 14/104,532

(22) Filed: Dec. 12, 2013

(30) Foreign Application Priority Data
Dec. 20, 2012 (JP) 2012-277725

(51) Int. Cl. B32B 3/02

(52) U.S. Cl. CPC B32B 3/02
USPC 428/38

(57) ABSTRACT

According to one embodiment, a display device includes a display module configured to display an image on a display area, a cover member including a transmissive portion opposed to the display area, and a color portion opposed to a peripheral area on an outside of the display area of the display module, and a photosensitive resin which attaches the display module and the cover member, wherein the color portion is formed of a color layer which passes light of a wavelength for curing the photosensitive resin.

### CROSS-REFERENCE TO RELATED APPLICATIONS

This application is based upon and claims the benefit of priority from Japanese Patent Application No. 2012-277725, filed Dec. 20, 2012, the entire contents of which are incorporated herein by reference.

### FIELD

Embodiments described herein relate generally to a display device and a cover member.

### BACKGROUND

In recent years, from the standpoint of ecological aspects such as saving in space and power, commercial products, which adopt liquid crystal panels or organic electroluminescence (EL) panels as display devices, have been gaining in popularity, as typified by liquid crystal monitors, liquid crystal televisions, mobile phones, smartphones, tablets, electronic books, and notebook-type personal computers. In particular, in various kinds of electronic devices such as smartphones, tablets, electronic books and mobile phones, use is made of touch panels which enable an information input by touching on screen surfaces thereof with use of fingers or the like, and cover glasses which cover outer peripheral parts other than screen display parts, as well as the display panels such as liquid crystal panels and organic EL panels.

As a technique of attaching thin plates such as a display panel, a touch panel and a cover glass, there is known a technique in which an ultraviolet-curing resin is coated on the surface of one thin plate, the other thin plate is laid over the one thin plate, and the resin is cured by ultraviolet irradiation after the resin has spread up to a necessary filling area.

In the meantime, taking into account the suppression of variance in amount of the resin that is coated, or the suppression of bubbles, for instance, it is difficult to restrict the area, where the resin is to be filled, to only a display area (hereinafter referred to as “active area”) which displays an image. Consequently, there is a case in which the filling area of resin extends outside the active area and reaches the outer peripheral part of the cover glass, which is covered with, for example, a light-shield layer which hardly passes light. In such a case, in the filling area of resin, an area, where ultraviolet that is necessary for curing does not easily reach, will occur under the light-shield layer. For example, since the area of the vicinity of a mounting portion of the display panel, on which a driving IC chip, etc. are mounted, is widely covered with a light-shield layer, ultraviolet hardly reaches this area. This area may possibly include an area where a non-cured resin exists. If the resin is left in the non-cured state, the spreading of the resin cannot be suppressed, and there is a concern that the spread resin may enter a gap in the display part and may cause a display defect, leading to degradation in quality.

In addition, recently, there has been an increasing demand for narrowing of a picture frame, in order to achieve both a compact size and a large active-area screen. Thus, as regards the display panel, too, since the width of the outer peripheral area has become smaller than the width of the active area, it has become more and more important to stem spreading of resin at the peripheral area. A resin, which has spread in a non-cured state and protrudes to the outside of the display panel, becomes an obstruction when the display panel is built in the electronic device body, and may lead to degradation in quality. Moreover, in the fabrication step of removing the protruding resin, the removed resin becomes a contaminant, resulting in a factor of degradation in quality.

### BRIEF DESCRIPTION OF THE DRAWINGS

FIG. 1 is a plan view which schematically illustrates an example of a display panel PNL which is applicable to a display device DSP according to an embodiment.

FIG. 2 is a cross-sectional view which schematically illustrates a cross section of the display device DSP including the display panel PNL shown in FIG. 1.

FIG. 3 is a plan view illustrating an example of a cover member CB shown in FIG. 2.

FIG. 4 is a cross-sectional view of a peripheral edge portion, taken along line A-B of the cover member CB shown in FIG. 3.

FIG. 5 is a view which schematically illustrates an example of a transmission spectrum of a material which is applicable to a color layer 11 of the cover member CB shown in FIG. 4.

FIG. 6 is a cross-sectional view which schematically illustrates a cross section of another example of the cover member CB which is applicable to the display device DSP of the embodiment.

FIG. 7 is a cross-sectional view which schematically illustrates a cross section of another example of the cover member CB which is applicable to the display device DSP of the embodiment.

FIG. 8 is a cross-sectional view which schematically illustrates a cross section of another example of the display device DSP including the display panel PNL shown in FIG. 1.

FIG. 9 is a plan view which schematically illustrates another example of the display device DSP including the display panel PNL shown in FIG. 1.

FIG. 10 is a cross-sectional view which schematically illustrates a cross section taken along line C-D of the display device DSP shown in FIG. 9.

FIG. 11 is a cross-sectional view which schematically illustrates a cross section of another example of the display device DSP including the display panel PNL shown in FIG. 1.

### DETAILED DESCRIPTION

In general, according to one embodiment, a display device includes a display module configured to display an image on a display area; a cover member including a transmissive portion opposed to the display area, and a color portion opposed to a peripheral area on an outside of the display area of the display module; and a photosensitive resin which attaches the display module and the cover member, wherein the color portion is formed of a color layer which passes light of a wavelength for curing the photosensitive resin.

According to another embodiment, a cover member disposed to be opposed to a display module configured to display an image on a display area, and attached to the display module by a photosensitive resin, the cover member includes a transmissive portion opposed to the display area; and a color portion opposed to a peripheral area on an outside of the display area of the display module, wherein the color portion is formed of a color layer which passes light of a wavelength for curing the photosensitive resin.

An embodiment will be described hereinafter with reference to the accompanying drawings. In the drawings, structural elements having the same or similar functions are denoted by like reference numerals, and an overlapping description is omitted.

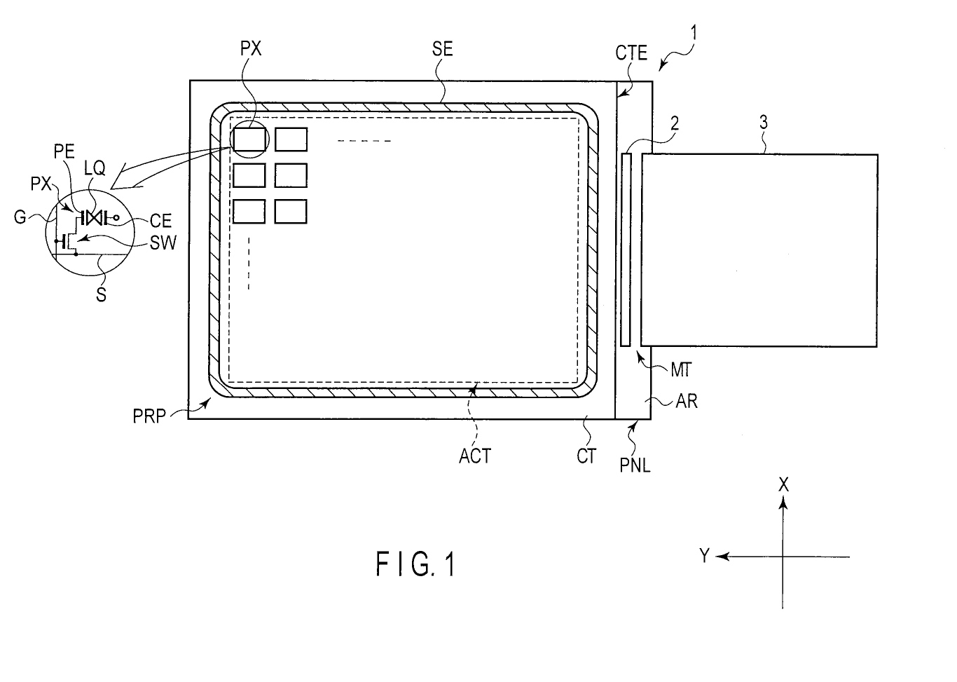

FIG. 1 is a plan view which schematically illustrates an example of a display panel PNL which is applicable to a display device DSP according to the embodiment. In the description below, a liquid crystal panel will be described as an example of the display panel PNL, but other display panels, such as an organic electroluminescence panel, may be applicable.

The display panel PNL is, for example, an active-matrix-type liquid crystal panel, and includes an array substrate AR, a counter-substrate CT which is disposed to be opposed to the array substrate AR, and a liquid crystal layer LQ which is held between the array substrate AR and the counter-substrate CT. The array substrate AR and the counter-substrate CT are attached by a sealant SE in a state in which a predetermined cell gap is formed between the array substrate AR and the counter-substrate CT. The cell gap is formed by columnar spacers which are formed on the array substrate AR or counter-substrate CT. The liquid crystal layer LQ is held in an inside surrounded by the sealant SE in the cell gap between the array substrate AR and the counter-substrate CT.

The display panel LPN includes an active area ACT, which displays an image, in the inside surrounded by the sealant SE. The active area ACT has, for example, a substantially rectangular shape, and is composed of a plurality of pixels PX which are arrayed in a matrix of m×n (m and n are positive integers).

The array substrate AR includes gate lines G extending in a first direction X, source lines S extending in a second direction Y which is perpendicular to the first direction X, a switching element SW which is connected to the gate line G and source line S, and a pixel electrode PE which is connected to the switching element SW. A counter-electrode CE, which is opposed to each pixel electrode PE via the liquid crystal layer LQ, is provided, for example, on the counter-substrate CT.

Although a description of the detailed structure of the liquid crystal panel is omitted, the display panel is configured such that a mode which mainly uses a vertical electric field, such as a TN (Twisted Nematic) mode, an OCB (Optically Compensated Bend) mode or a VA (Vertical Aligned) mode, or a mode which mainly uses a lateral electric field, such as an IPS (In-Plane Switching) mode or an FFS (Fringe Field Switching) mode, is applicable to the display panel. In the structure in which a mode using a lateral electric field is applied, both the pixel electrode PE and counter-electrode CE are provided on the array substrate AR.

Signal supply sources which are necessary for driving the display panel PNL, such as a driving IC chip 2 and a flexible printed circuit (FPC) board 3, are located on a peripheral area PRP on the outside of the active area ACT. In the example illustrated, the driving IC chip 2 and FPC board 3 are mounted on a mounting portion MT of the array substrate AR, which extends outward from a substrate end portion CTE of the counter-substrate CT. The peripheral area PRP is an area surrounding the active area ACT, includes an area on which the sealant SE is disposed, and is formed in a rectangular frame shape.

In the meantime, the above-described display panel PNL may include a touch sensor for sensing a touch of an object on a detection surface (e.g. a surface of a cover member to be described later), in addition to a function of displaying an image on the active area ACT. In addition, the touch sensor may be disposed on the detection surface side of the counter-substrate of the display panel PNL. Although a description of the details of the touch sensor is omitted, for example, an electrostatic-capacitance method, which detects a variation in electrostatic capacitance of a sensing wiring, is applicable.

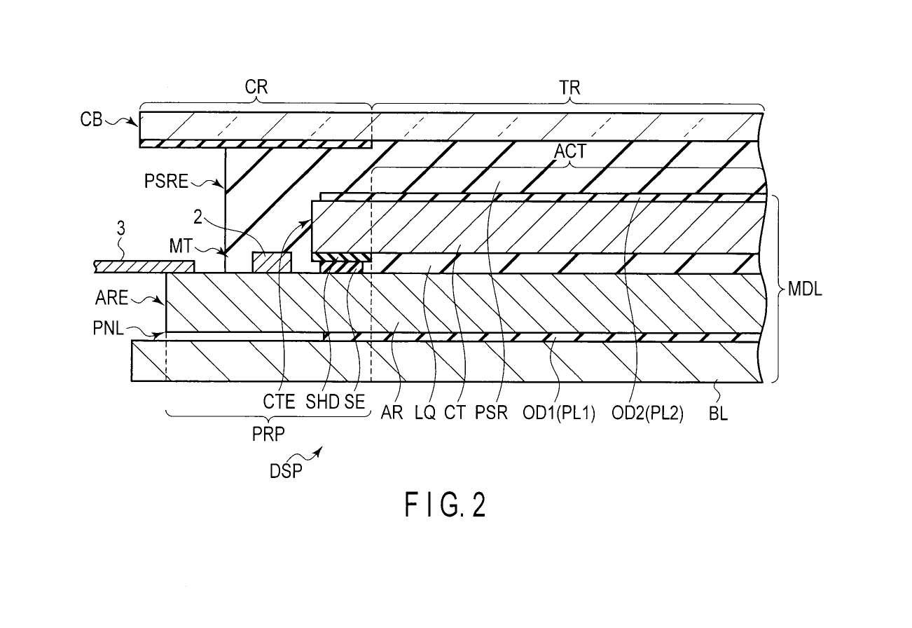

FIG. 2 is a cross-sectional view which schematically illustrates a cross section of the display device DSP including the display panel PNL shown in FIG. 1.

The display device DSP includes a display module MDL which displays an image on the active area ACT, a cover member CB which is disposed to be opposed to the display module MDL, and a photosensitive resin PSR which attaches the display module MDL and the cover member CB to each other. In the example illustrated, the display module MDL includes the display panel PNL shown in FIG. 1A and a backlight BL. Incidentally, the display panel PNL and the backlight BL may be formed integral.

The backlight BL is disposed on the back side of the display panel PNL. Various modes are applicable to the backlight BL. As the backlight BL, use may be made of either a backlight which utilizes a light-emitting diode (LED) as a light source, or a backlight which utilizes a cold cathode fluorescent lamp (CCFL) as a light source. A description of the detailed structure of the backlight BL is omitted.

In the display panel PNL, the liquid crystal layer LQ is held between the array substrate AR and the counter-substrate CT. The array substrate AR and counter-substrate CT are attached by the sealant SE. A detailed description of the structure of the inner surface side of the array substrate AR, which is opposed to the counter-substrate CT, is omitted. A first optical element OD1 including a first polarizer PL1 is attached to an outer surface of the array substrate AR, which is opposed to the backlight BL. The first optical element OD1 is disposed over the entirety of the active area ACT, and also extends to the peripheral area PRP.

Although a detailed description of the structure of the inner surface side of the counter-substrate CT, which is opposed to the array substrate AR, is omitted, a peripheral light-shield layer SHD is formed. The peripheral light-shield layer SHD is formed at a periphery of the active area ACT. Although not described in detail, the peripheral light-shield layer SHD is formed in a rectangular frame shape surrounding the active area ACT. Specifically, the peripheral light-shield layer SHD is disposed at the peripheral area PRP of the display panel PNL. A second optical element OD2 including a second polarizer PL2 is attached to an outer surface of the counter-substrate CT, which is opposed to the cover member CB. The second optical element OD2 is disposed over the entirety of the active area ACT. Further, the second optical element OD2 also extends to the peripheral area PRP, and an end portion of the second optical element OD2 is located at a position overlapping the peripheral light-shield layer SHD.

In the display panel PNL, the peripheral area PRP includes an area where the peripheral light-shield layer SHD is disposed, and an area outside the peripheral light-shield layer SHD. This peripheral area PRP also includes a mounting portion MT outside a substrate end portion CTE of the counter-substrate CT. The driving IC chip 2 and FPC board 3, which are signal supply sources, are mounted on the mounting portion MT of the array substrate AR. The driving IC chip 2 is mounted on that side of the mounting portion MT, which is closer to the active area ACT, that is, at a position closer to the substrate end portion CTE. The FPC board 3 is mounted on the outside of the driving IC chip 2 on the mounting portion MT, that is, at a position closer to a substrate end portion ARE of the array substrate AR.

The cover member CB includes a transmissive portion TR and a color portion CR. The transmissive portion TR is transparent, and is opposed to the active area ACT of the display module MDL. The color portion CR is located outside the transmissive portion TR. This color portion CR is opposed to the peripheral area PRP of the display module MDL. Needless to say, the color portion CR is also opposed to the signal supply sources (driving IC chip 2 and FPC board 3). The color portion CR neighbors the transmissive portion TR, and is opposed to an end portion of the second optical element OD2, the substrate end portion CTE of the counter-substrate CT and the substrate end portion ARE of the array substrate AR, which are located in the peripheral area PRP of the display panel PNL. In addition, the color portion CR is also located above the peripheral light-shield layer SHD. The concrete structure of the cover member CB will be described later.

The color of the color portion CR may be black, or other color variations may be adopted. Specifically, the color portion CR is colored so as to suppress visual recognition of the peripheral area PRP of the display module MDL when the display device is observed from the front surface side of the cover member CB (or so as to prevent light from entering the peripheral area PRP of the display module MDL from the front surface side of the cover member CB).

The photosensitive resin PSR is formed of a transparent material which is cured by irradiation of light of a specific wavelength, for example, an ultraviolet-curing acrylic resin which is cured by irradiation of ultraviolet (e.g. light of a wavelength range of 380 nm or less). The photosensitive resin PSR is interposed between the front surface of the display module MDL and the back surface of the cover member CB. In the example illustrated, on the display module MDL side, the photosensitive resin PSR is in contact with the second optical element OD2, the substrate end portion CTE of the counter-substrate CT, and the surface of the array substrate AR at the mounting portion MT, and the photosensitive resin PSR covers the driving IC chip 2 of the mounting portion MT. In addition, on the cover member CB side, the photosensitive resin PSR is in contact with the transmissive portion TR and the color portion CR. Specifically, the photosensitive resin PSR is interposed between the transmissive portion TR and color portion CR of the cover member CB, on one hand, and the display module MDL, on the other hand. Incidentally, the photosensitive resin PSR may also cover the FPC board 3.

An edge PSRE of the photosensitive resin PSR is located on the outside of the transmissive portion TR of the cover member CB, and is located on the outside of the active area ACT of the display module MDL. Specifically, the edge PSRE of the photosensitive resin PSR is located at a position immediately below the color portion CR. The edge PSRE may be set in the vicinity of the substrate end portion CTE, or may be positioned on the FPC substrate.

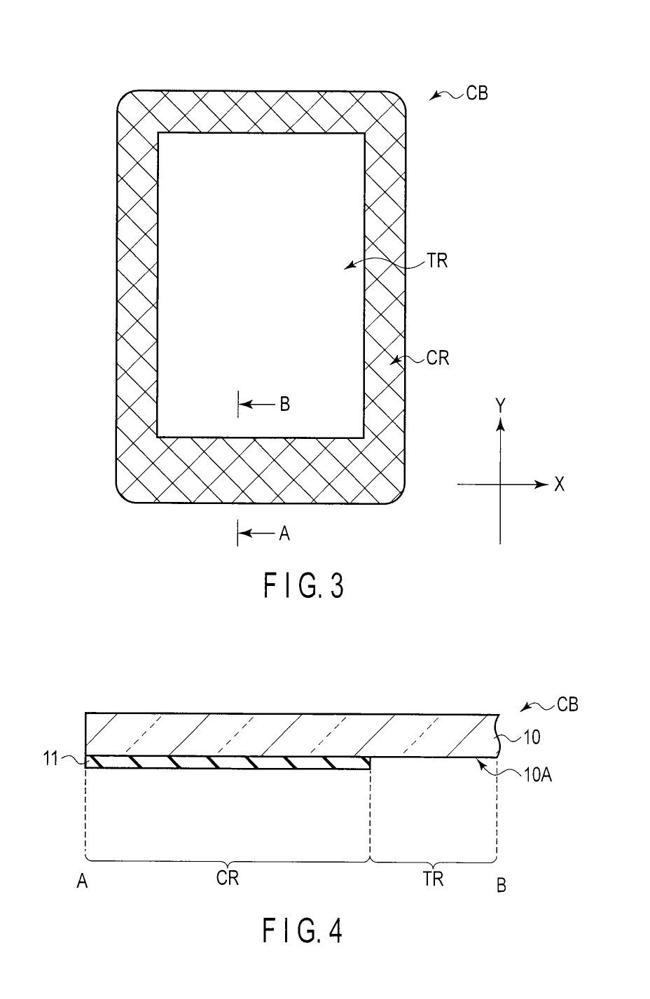

FIG. 3 is a plan view illustrating an example of the cover member CB shown in FIG. 2.

The cover member CB has, for example, a substantially rectangular shape having short sides in the first direction X and long sides in the second direction Y. The transmissive portion TR is located at a substantially central part of the cover member CB, and has a shape corresponding to the shape of the active area ACT. In the example illustrated, the shape of the transmissive portion TR is rectangular. The color portion CR is an area indicated by cross-hatching in the Figure, and is formed in a frame shape surrounding the transmissive portion TR. In the example illustrated, the color portion CR has a frame shape which is continuously formed around the transmissive portion TR and extends to the respective sides of the cover member CB.

FIG. 4 is a cross-sectional view of a peripheral edge portion, taken along line A-B of the cover member CB shown in FIG. 3.

Specifically, the cover member CB is configured to include a transparent substrate 10 and a color layer 11 which forms the color portion CR. The substrate 10 is a transparent glass plate or plastic plate, and the thickness thereof is not specified. The substrate 10 may have a relatively thin film shape or a relatively thick planar plate shape. The color layer 11 is disposed on an inner surface 10A (or the side opposed to the display module) of the substrate 10 over substantially the entirety of the color portion CR, and is not disposed in the transmissive portion TR.

The color layer 11 is formed of a material which passes light of a wavelength that is radiated in order to cure the photosensitive resin PSR. As described above, when the photosensitive resin PSR is an ultraviolet-curing type resin, the color portion CR is formed of the color layer 11 which passes light of an ultraviolet wavelength. For example, the color layer 11, which exhibits black, is formed of a material containing a dark azo organic pigment (black pigment) in a base material which is formed of an organic material. The color layer 11 is formed by using such a method as printing, evaporation deposition, or photolithography.

In the meantime, the cover member CB may further include a transparent overcoat layer which covers the inner surface 10A of the substrate 10 in the transmissive portion TR, and the color layer 11. The overcoat layer is formed of, for example, a transparent resin, and planarizes asperities on the inner surface 10A and the color layer 11.

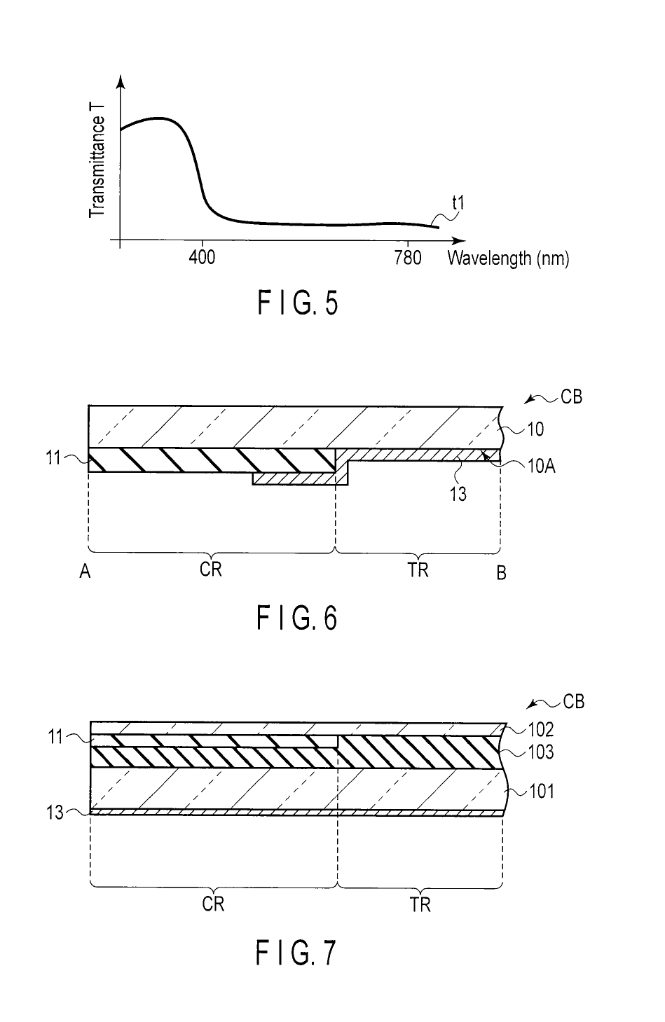

FIG. 5 is a view which schematically illustrates an example of a transmission spectrum of a material which is applicable to the color layer 11 of the cover member CB shown in FIG. 4.

In FIG. 5, the abscissa indicates wavelength (nm), and the ordinate indicates transmittance T. A transmission spectrum t1 of the color layer 11 exhibits a relatively high transmittance at ultraviolet wavelengths of 400 nm or less, and exhibits a lower transmittance at visible light wavelengths of 400 nm to 780 nm than at the ultraviolet wavelengths. In particular, when the color layer 11 is black, the transmittance at visible light wavelengths is very low.

In this structure, the display device DSP is fabricated, for example, in the following manner. Specifically, a photosensitive resin PSR in a non-cured state (or in a liquid state) is coated on the surface of the display panel PNL, that is, on the surface of the second optical element OD2 and the mounting portion MT including the driving IC chip 2. After the cover member CB is placed on the photosensitive resin PSR, the cover member CB is properly pressurized and the photosensitive resin PSR is spread out. After the photosensitive resin PSR is so spread as to cover the entirety of the active area ACT, ultraviolet is radiated on the front surface side of the cover member CB from a light source such as a halogen lamp. The ultraviolet, which has passed through the transmissive portion TR, is radiated on the photosensitive resin PSR which is located in the active area ACT. In addition, the ultraviolet, which has passed through the color portion CR, is radiated on the entirety of the photosensitive resin PSR which has spread in the peripheral area PRP. Thereby, the whole photosensitive resin PSR is cured and the spreading thereof is stopped, and therefore the edge PSRE is located immediately below the color portion CR. It is thus possible to suppress the occurrence of an area where non-cured photosensitive resin PSR exists.

Accordingly, even in the case of a display device DSP of a narrow picture-frame type, or in the case of a display device DSP to which a display module MDL with a narrow peripheral area PRP is applied, the spreading of the photosensitive resin PSR to the outside of the peripheral area PRP can be suppressed, while the photosensitive resin PSR can be disposed over the entire active area ACT.

In addition, the occurrence of a problem due to undesired spreading of non-cured photosensitive resin can be suppressed. For example, entrance of spread resin into a gap of the display panel PNL can be suppressed, and degradation in quality due to the occurrence of a display defect can be suppressed. Furthermore, it is possible to suppress protrusion of the photosensitive resin PSR to the outside of the display module MD, and to suppress degradation in quality.

Besides, a fabrication step of removing protruding resin is needless, and it is possible to suppress the occurrence of a contaminant, and to reduce the number of fabrication steps. Moreover, in order to promote curing of non-cured resin, there is no need to add a new process of radiating ultraviolet from the lateral surface side or back surface side of the display module MDL, in addition to the process of radiating ultraviolet from the front surface side of the cover member CB, and the manufacturing equipment can be made simpler.

Next, other structure examples are described.

FIG. 6 is a cross-sectional view which schematically illustrates a cross section of another example of the cover member CB which is applicable to the display device DSP of the embodiment.

The cover member CB of the illustrated example is configured to include a transparent substrate 10, a color layer 11, and a touch sensor 13. The substrate 10 and color layer 11 are the same as those described above, and a description thereof is omitted here. The touch sensor 13 includes, for instance, a sensing wiring which is formed of a transparent, electrically conductive material (e.g., ITO). The touch sensor 13 is provided, for example, on the display module side of the substrate 10. The touch sensor 13 is disposed in the transmissive portion TR. In the example illustrated, the touch sensor 13 is disposed on the inner surface 10A of the substrate 10. In addition, that part of the touch sensor 13, which is located in the color portion CR, overlaps the color layer 11, and the sensing wiring, etc. are led out to the periphery of the cover member CB. In particular, the touch sensor 13 overlaps the display module side of the color layer 11. Thus, even in the case where the sensing wiring, etc. are formed of an opaque metal, the color portion CR can be hidden by the color layer 11 when the display device is observed from the front surface side of the cover member CB, and the sensing wiring, etc. can be prevented from being exposed via the substrate 10. Although not shown, the cover member CB may further include a transparent overcoat layer which covers the color layer 11 and the touch sensor 13.

Also in the case where the cover member CB of this structure example is applied, the same advantageous effects as with the above-described structure example can be obtained.

FIG. 7 is a cross-sectional view which schematically illustrates a cross section of another example of the cover member CB which is applicable to the display device DSP of the embodiment.

The cover member CB of the illustrated example is configured to include a first substrate 101 which is transparent and has a touch sensor 13 provided on the display module side thereof, and a second substrate 102 which is transparent and has a color layer 11 provided on the display module side thereof. For example, the first substrate 101 is a glass substrate with a relatively thick planar plate shape, and the second substrate 102 is a film having a less thickness than the first substrate 101. An outer surface of the first substrate 101, which is opposite to the touch sensor 13, is opposed to the second substrate 102, and the first substrate 101 and second substrate 102 are attached by an adhesive 103.

Also in the case where the cover member CB of this structure example is applied, the same advantageous effects as with the above-described structure example can be obtained.

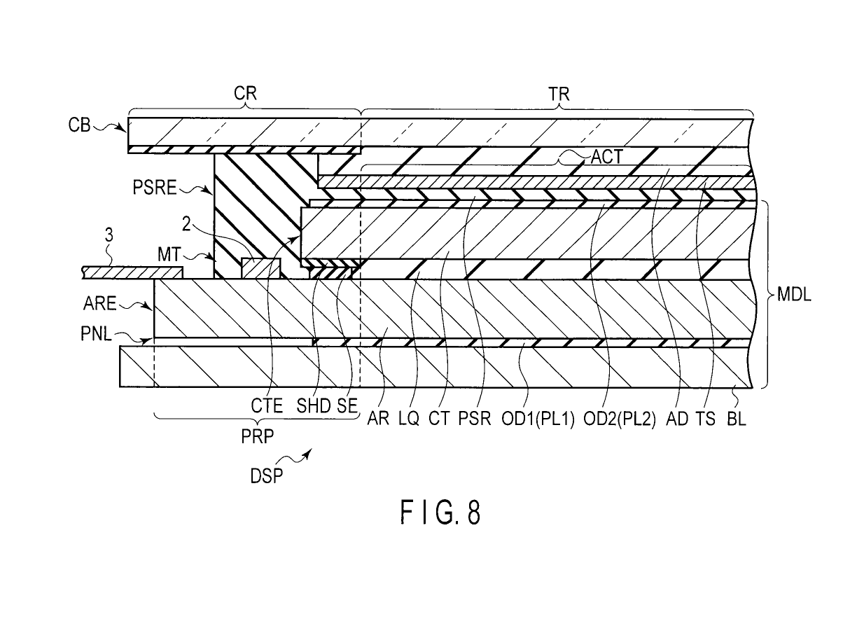

FIG. 8 is a cross-sectional view which schematically illustrates a cross section of another example of the display device DSP including the display panel PNL shown in FIG. 1A.

The display device DSP of the illustrated example differs from the above-described display device DSP in that a touch sensor TS is provided between the display module MDL and the cover member CB.

Although a detailed description of the touch sensor TS is omitted, a sensing wiring, etc., which are formed of a transparent, electrically conductive material (e.g., ITO), are provided on a transparent support substrate such as a glass substrate or a resin substrate, and the touch sensor TS is formed in a shape of a transparent planar plate. The touch sensor TS is opposed, for example, to the entirety of the active area ACT. The touch sensor TS is attached to the display module MDL side of the cover member CB by an adhesive AD. This adhesive AD is, for example, an ultraviolet-curing resin. In the state in which the adhesive AD is interposed between the cover member CB and the touch sensor TS, ultraviolet is radiated from the transparent touch sensor TS side, whereby the adhesive AD is cured, and the adhesive AD attaches the cover member CB and the touch sensor TS.

The photosensitive resin PSR is interposed between the surface of the display module MDL (i.e. the front surface of the second optical element PD2) and the touch sensor TS.

As regards the fabrication method of the display device DSP, for example, after the touch sensor TS is attached to the cover member CB by the adhesive AD, the touch sensor TS is attached to the display panel PNL by the photosensitive resin PSR. However, after the touch sensor TS is attached to the display panel PNL, the touch sensor TS may be attached to the cover member CB.

Also in the case where the display module MDL of this structure example is applied, the same advantageous effects as with the above-described structure example can be obtained.

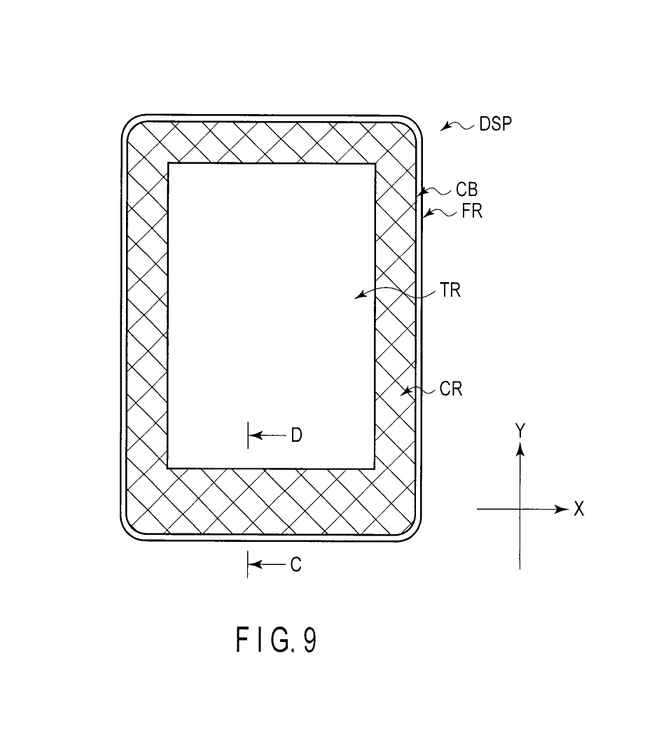

FIG. 9 is a plan view which schematically illustrates another example of the display device DSP including the display panel PNL shown in FIG. 1.

The display device DSP of the illustrated example differs from the above examples in that the cover member CB is formed integral with a frame FR. In the above-described examples, the cover member CB is attached to a frame after the cover member CB is attached to the display module MDL via the photosensitive resin PSR. In the example illustrated, the cover member CB and frame FR, which are formed integral in advance, are applied. The frame FR is formed in a frame shape surrounding the cover member CB.

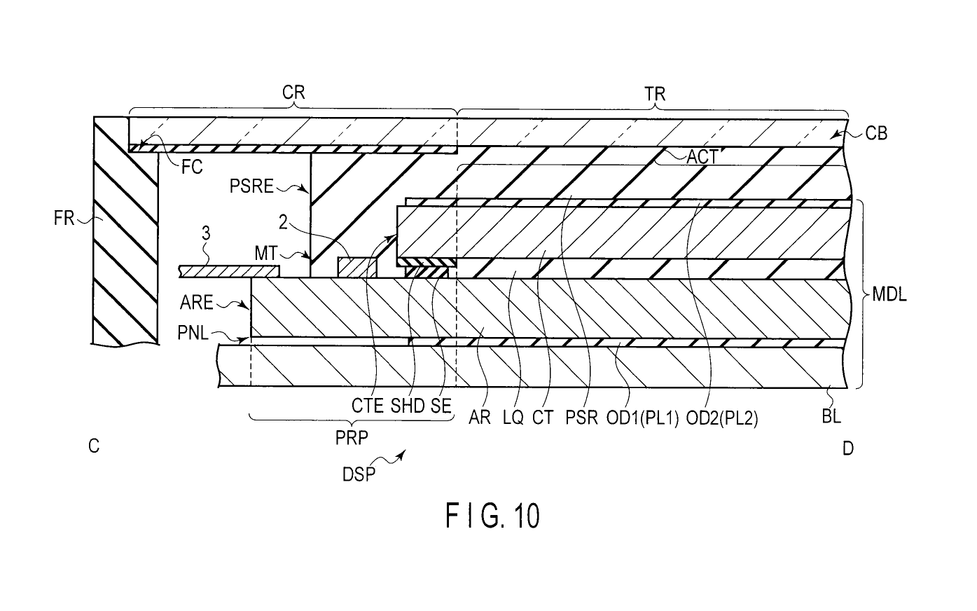

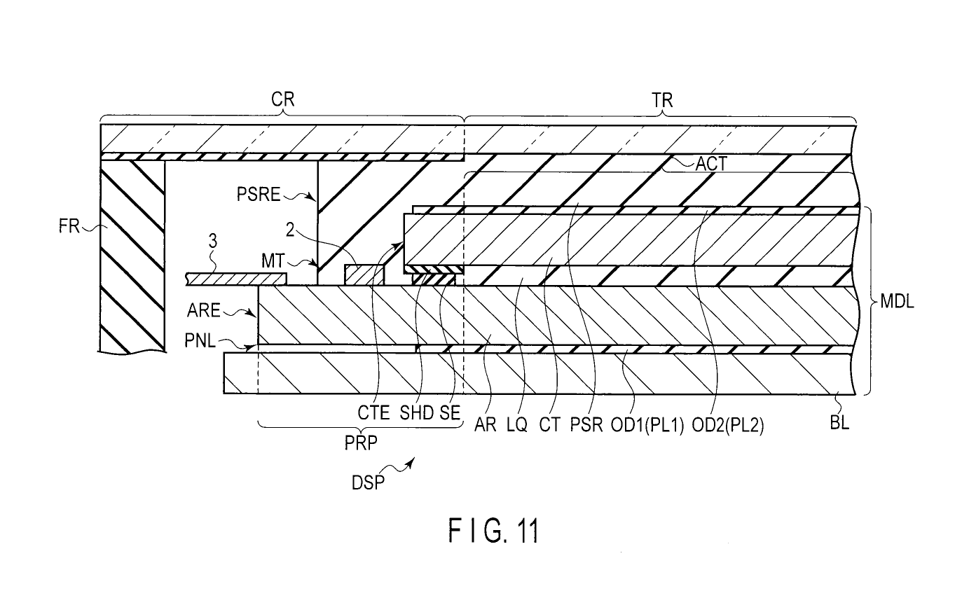

FIG. 10 is a cross-sectional view which schematically illustrates a cross section taken along line C-D of the display device DSP shown in FIG. 9.

The frame FR includes a recess portion FC which receives the cover member CB. In the cross section illustrated, the frame FR extends substantially vertically toward the backlight BL from the recess portion FC which receives the cover member CB, and is formed to be continuous with the backlight BL at the bottom part, although not illustrated. The frame FR is opposed to the edge PSRE of the photosensitive resin PSR. In the state in which the frame FR is formed integral with the cover member CB in advance, it is difficult to radiate ultraviolet from the side surface side of the display module MDL at a time of curing the photosensitive resin PSR. However, in the present embodiment, as described above, by radiating ultraviolet from only the front surface side of the cover member CB, the ultraviolet which has passed through the transmissive portion TR is radiated on the photosensitive resin PSR which is located in the active area ACT. In addition, since the ultraviolet which has passed through the color portion CR is radiated on the entirety of the photosensitive resin PSR which spreads to the peripheral area PRP, the entire photosensitive resin PSR is cured, and the occurrence of a non-cured region can be suppressed. Therefore, according to this structure example, the same advantageous effects as with the above-described example can be obtained, regardless of the structure of the display module MDL, the presence/absence of the touch sensor TS, and the position of the touch sensor TS.

FIG. 11 is a cross-sectional view which schematically illustrates a cross section of another example of the display device DSP including the display panel PNL shown in FIG. 1.

The display device DSP of the example illustrated here is different from the above-described example in that the cover member member CB is supported by an end face of the frame FR which is formed integral with the cover member CB. Specifically, the frame FR does not include the recess portion FC which receives the cover member CB. In the cross section illustrated, the frame FR extends substantially vertically toward the backlight BL from the back surface side of the cover member CB.

Also in the case where this structure example is applied, the same advantageous effects as with the above-described structure example can be obtained.

As has been described above, according to the present embodiment, it is possible to provide a display device and a cover member, which can suppress degradation in quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display module configured to display an image on a display area;
a cover member including a transmissive portion opposed to the display area, and a color portion opposed to a peripheral area on an outside of the display area of the display module; and
a photosensitive resin which attaches the display module and the cover member,
wherein the color portion is formed of a color layer which passes light of a wavelength for curing the photosensitive resin.

2. The display device of claim 1, wherein the photosensitive resin is interposed between the transmissive portion and the color portion of the cover member, on one hand, and the display module, on the other hand.

3. The display device of claim 1, wherein the display module further includes a signal supply source, and
the color portion is formed in a frame shape surrounding the transmissive portion, and is opposed to the signal supply source.

4. The display device of claim 3, wherein the photosensitive resin covers the signal supply source.

5. The display device of claim 1, wherein the color layer is formed of a material containing a dark azo organic pigment in a base material which is formed of an organic material.

6. The display device of claim 1, wherein the photosensitive resin is an ultraviolet-curing resin, and the color portion is formed of a color layer which passes light of an ultraviolet wavelength.

7. The display device of claim 1, wherein the display module incorporates a touch sensor.

8. The display device of claim 1, further comprising a touch sensor between the display module and the cover member.

9. The display device of claim 1, wherein the cover member includes a transparent substrate, a touch sensor disposed over at least the transmissive portion on that side of the transparent substrate, which is opposed to the display module, and a color layer disposed at the color portion on that side of the transparent substrate, which is opposed to the display module.

10. The display device of claim 1, wherein the cover member is formed integral with a frame.

11. The display device of claim 10, wherein the frame is opposed to an edge of the photosensitive resin.

12. A cover member disposed to be opposed to a display module configured to display an image on a display area, and attached to the display module by a photosensitive resin, the cover member comprising:
a transmissive portion opposed to the display area; and
a color portion opposed to a peripheral area on an outside of the display area of the display module,
wherein the color portion is formed of a color layer which passes light of a wavelength for curing the photosensitive resin.

13. The cover member of claim 12, further comprising a touch sensor.

14. The cover member of claim 12, wherein the cover member is formed integral with a frame.

15. The cover member of claim 14, wherein the frame member is opposed to an edge of the photosensitive resin.
